(19) United States
(12) Patent Application Publication
(10) Pub. No.: US 2007/0234227 A1
(43) Pub. Date: Oct. 4, 2007

(54) Apparatus and method for selecting multiple items in a graphical user interface

(75) Inventors: Edward John Prinsen, Vancouver (CA); Yan Deng Chen, Santa Clara, CA (US)

Correspondence Address: COOLEY GODWARD KRONISH LLP;ATTN: Patent Group, Suite 500, 1200 - 19th Street, NW, Washington, DC, 20036-2402, US

(73) Assignee: Business Objects, S.A., Levallois-Perret (FR)

(21) Appl. No.: 11/394,639

(22) Filed: Mar. 31, 2006

(51) Int. Cl. G06F 9/00

(52) U.S. Cl. 715/769; 715/810; 715/835; 715/770

(57) ABSTRACT

A computer readable medium includes executable instructions to identify an alternative selection mode within a graphical user interface. A set of selected items are linked during the alternative selection mode in response to single input action selection of each item.

### BRIEF DESCRIPTION OF THE INVENTION

This invention relates generally to a graphical user interface for a computer. More particularly, this invention relates to selecting multiple items in a graphical user interface.

### BACKGROUND OF THE INVENTION

Multiple selections in a graphical user interface allow more than one item to be selected such that a collective operation using all items can be performed. Sometimes the selection of items defines the input to the collective operation and, therefore, precision is important. In particular, a user may wish to perform an operation on a small portion of items from a set of items that are contained non-sequentially, and have no common sub-string in their name.

### In graphical user interfaces (GUIs) of the prior art there are a number of methods for multiple selections. Including:

1) Contiguous selections that are made with pointer clicks and the pressing of a key, such as, “SHIFT”. The user defines a range of items by clicking on a start item, and while holding the appropriate key down, clicking on an end item. In this way a contiguous group of items can be selected.
2) Non-contiguous selections can be made by clicking on a series of items while holding a key down, e.g., holding down “CTRL”. A user discriminately selects items by clicking on one or more items.
3) Contiguous selections can be made by dragging. The user selects a range of items by placing the cursor in an anchor position at one corner of the range and half-clicks the mouse button. Without releasing the mouse button, the user moves the cursor in any direction. When the desired range is selected, the user releases the mouse button.
   The use of a keyboard input along with clicking a button on a pointer is called a controlled click. The foregoing prior art methods do not aid in the selection of items where precision and discrimination are important, nor do they minimize user-driven events, e.g., mouse clicks and keyboard inputs.

In the prior art there are some GUIs in which the user can activate a “Click Lock” feature such that the interface emulates the holding down of a mouse button during a drag operation. Instead of having to hold the mouse button down for the duration of highlighting and dragging, the user presses and holds the mouse button down for a brief period and the computer locks the input from the button as if it were in the depressed state. In some GUIs the user begins the drag motion prior to releasing the mouse button. The input is unlocked when the user presses the button again. This feature is found in many operating systems' GUIs, including Windows XP™, and is useful to people with who lack mobility. However, this requires that item selection be done individually for a plurality of items as Click Lock does not support group selection. For example, if a user tries to copy a file and a folder to another location by first clicking on the file and then clicking on a folder, the file will be moved into the folder. Also, Click Lock does not support the de-selection of items by re-clicking on a previously selected item.

In view of the foregoing, it would be desirable to provide improved techniques for manipulating items. In particular, it would be desirable to provide a better set of apparatus and techniques for selecting items in a GUI.

### SUMMARY OF INVENTION

The invention includes a computer readable medium with executable instructions to identify an alternative selection mode within a graphical user interface. A set of selected items are linked during the alternative selection mode in response to single input action selection of each item.

### BRIEF DESCRIPTION OF THE FIGURES

The invention is more fully appreciated in connection with the following detailed description taken in conjunction with the accompanying drawings, in which:

FIG. 1 illustrates a computer configured in accordance with an embodiment of the invention.

FIG. 2 illustrates a series of processing operations associated with an embodiment of the invention.

FIG. 3 illustrates a graphical user interface (GUI) configured in accordance with an embodiment of the invention.

FIGS. 4A, 4B and 4C each illustrate a workflow for a portion of the GUI of FIG. 3.

FIG. 5 illustrates a workflow for the GUI of FIG. 3.

FIG. 6 illustrates the results of the workflow of FIGS. 4A, 4B, 4C, and 5.

FIG. 7 illustrates a GUI and workflow in accordance with an embodiment of the invention.

FIG. 8 illustrates a GUI and workflow in accordance with an embodiment of the invention.

FIG. 9 illustrates a state diagram associated with an embodiment of the invention.

Like reference numerals refer to corresponding parts throughout the several views of the drawings.

### DETAILED DESCRIPTION OF THE INVENTION

Various features associated with the operation of the present invention will now be set forth. Prior to such description, a glossary of terms used throughout this description is provided.

Click is a depression and release of a button.

Cross-tab. A cross-tab (abbreviation of cross-tabulation) is a visualization of data that displays the joint distribution of two or more variables simultaneously. Cross-tabs are usually presented in a matrix format. Each cell shows the value associated with the specific combination of row and column headings.

Drag-and-drop is the action of clicking on an item and dragging it to a different location or onto another item. In general, it can be used to invoke many kinds of actions, such as copying or moving, or create various types of associations between two items.

Focus is the item of the graphical user interface (GUI ) which is currently selected or the region of a graphical user interface that is activated and ready to accept inputs from a user.

Half-click is a depression of a button without release prior to another action, e.g., a drag operation.

Input signal. Computer input devices, such as, mice and keyboards take as input physical movement that the human user outputs and converts the movement into an input signal that a computer can understand.

Item. An item is a representation of a file, data, a program, or the like, in a GUI.

Point-and-click is the action of a user moving a cursor to a certain location on an output device and then clicking a button on a mouse or other pointing device.

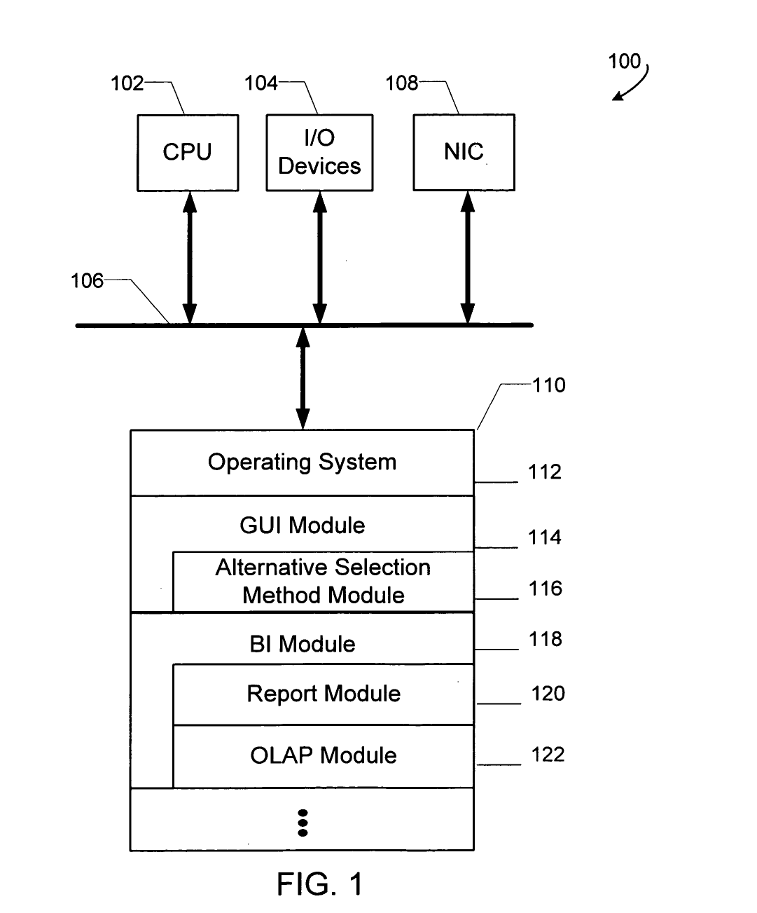

FIG. 1 illustrates a computer 100 configured in accordance with an embodiment of the invention. The computer 100 includes standard components, including a central processing unit 102 and input/output devices 104, which are linked by a bus 106. The input/output devices 104 may include a keyboard, mouse, touch screen, monitor, printer, and the like. A network interface circuit 108 is also connected to the bus 106. The network interface circuit 108 provides connectivity to a network (not shown), thereby allowing the computer 100 to operate in a networked environment.

A memory 110 is also connected to the bus 106. In an embodiment, the memory 110 stores one or more of the following modules: an operating system module 112, a Graphical User Interface (GUI) module 114, an alternative selection method module 116, a BI module 118, a report module 120, and an OLAP module 122.

The operating system module 112 may include instructions for handling various system services, such as file services or for performing hardware dependant tasks. The GUI module 114 may rely upon standard techniques to produce graphical components of a user interface, e.g., windows, icons, buttons, menus and the like, examples of which are discussed below. The user interface may include instructions to receive input from a pointer device and display a cursor on an output device. The alternative item selection module 116 includes executable instructions for selecting items in a GUI. The BI module 118 includes executable instructions to perform Business Intelligence (BI) related functions, such as, generate reports, perform queries and analyses, and the like. The BI module 118 can include the report module 120 or the OLAP module 122.

The executable modules stored in memory 110 are exemplary. It should be appreciated that the functions of the modules maybe combined. In addition, the functions of the modules need not be performed on a single machine. Instead, the functions may be distributed across a network, if desired. Indeed, the invention is commonly implemented in a client-server environment with various components being implemented at the client-side and/or the server-side. It is the functions of the invention that are significant, not where they are performed or the specific manner in which they are performed.

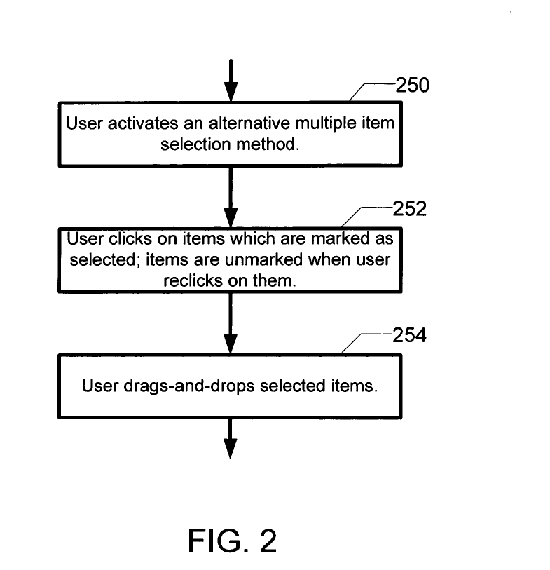

FIG. 2 illustrates processing operations that a user may execute on computer 100. In the first processing operation of FIG. 2, the user activates an alternative selection method 250. For example, the user may select “Multiple Item Selection” in an options menu of a GUI. The alternative item selection could also be activated by a change in focus of the GUI. Also, a user can activate the alternative item selection with a keyboard input or clicking on an icon. In an alternative embodiment, the alternative item selection is activated by default.

In processing operation 252 the user clicks on items in the GUI. Each selected item is highlighted as being selected by the GUI if the item was previously an unselected item. The processing operation 252 further includes deselecting each previously selected item the user clicks on. In processing operation 252, one or more selected items are assembled by the user, making one or more single clicks on each item. In accordance with an aspect of the invention, the clicks on the previously unselected items are not controlled clicks.

In processing operation 254 the user performs a drag-and-drop operation with the selected items. Upon the completion of the drag-and-drop operation all items are deselected, and their highlighting is removed.

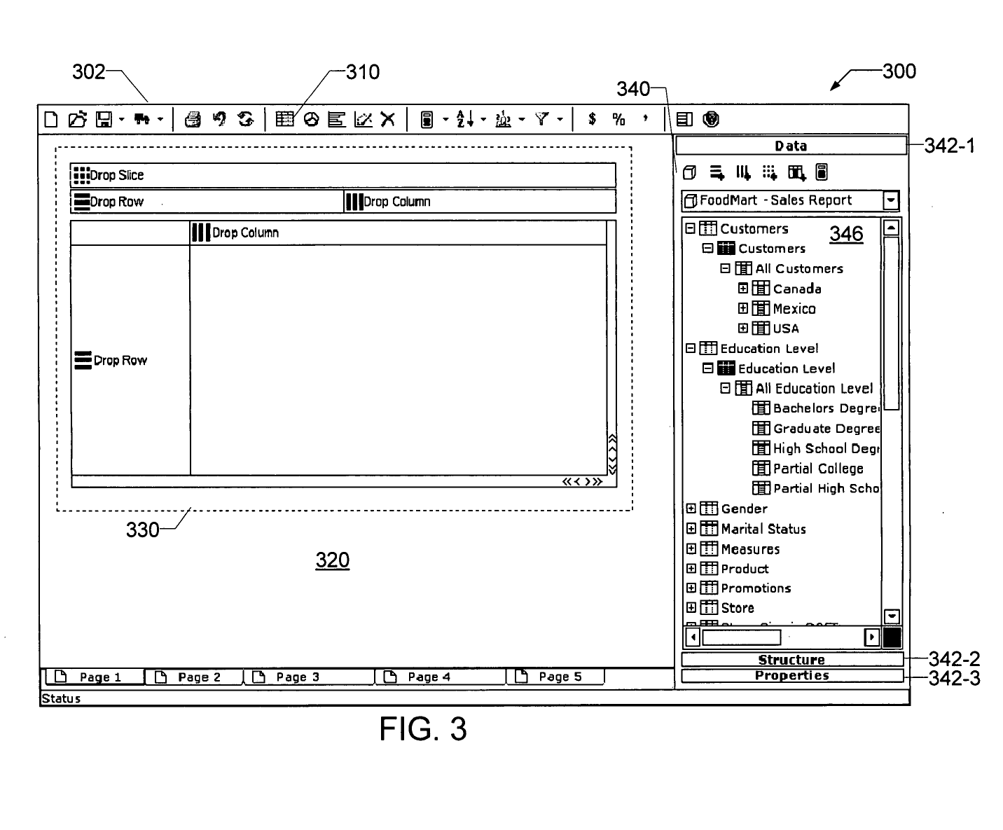

FIG. 3 illustrates a graphical user interface 300 configured in accordance with an embodiment of the invention. The GUI 300 could be included in a window presented on an output device of computer 100. The window is divided into two or more pane. The GUI 300 includes a tool bar 302. The icons in the tool bar include: formatting icons, analysis icons, component icons, and the like. The component icons include buttons that represent all of the visual components that can be used in the layout pane 320.

GUI 300 is an example of an OLAP tool. OLAP tools are a subset of business intelligence tools. There are a number of commercially available OLAP tools including Business Objects OLAP Intelligence™ which is available from Business Objects Americas of San Jose, Calif. OLAP generally refers to a technique of providing fast analysis of shared multi-dimensional information stored in a database. OLAP systems provide a multi-dimensional conceptual view of data, including full support for hierarchies and multiple hierarchies. This framework is used because it is the most logical way to analyze businesses and organizations. In some OLAP tools the data is arranged in a schema which simulates a multidimensional schema. The multi-dimensional schema means redundant information is stored, but it allows for users to initiate queries without the need to write SQL queries or otherwise know how the data is organized. In using an OLAP tool a user needs to discriminately select items to initiate a query.

A cross-tab 330 can be added to the layout pane 320 by selecting an icon on the visual components toolbar 310 and dragging the cursor to the layout pane. The layout pane 320 is the area where a user places and manipulates visual components. In an embodiment, the layout pane is freeform, allowing users to place the visual components in any location, including overlapping placements.

One embodiment of the present invention includes a side pane 340. The side pane 340 contains a number of tabs 342. In an embodiment, the tabs organize regions of input and output items related to BI activities such as report authoring and analysis. The tabs 342 can include: data 342-1, structure 342-2, properties 342-3, etc. The tabs can be used to navigate the content that is contained in the side pane 340. When a tab is selected, a region is displayed. Shown is a data region 346, including a series of items related to data in a data store arranged in trees. Items in the side pane 340 can be moved or copied to layout pane 320 in accordance with aspects of the present invention.

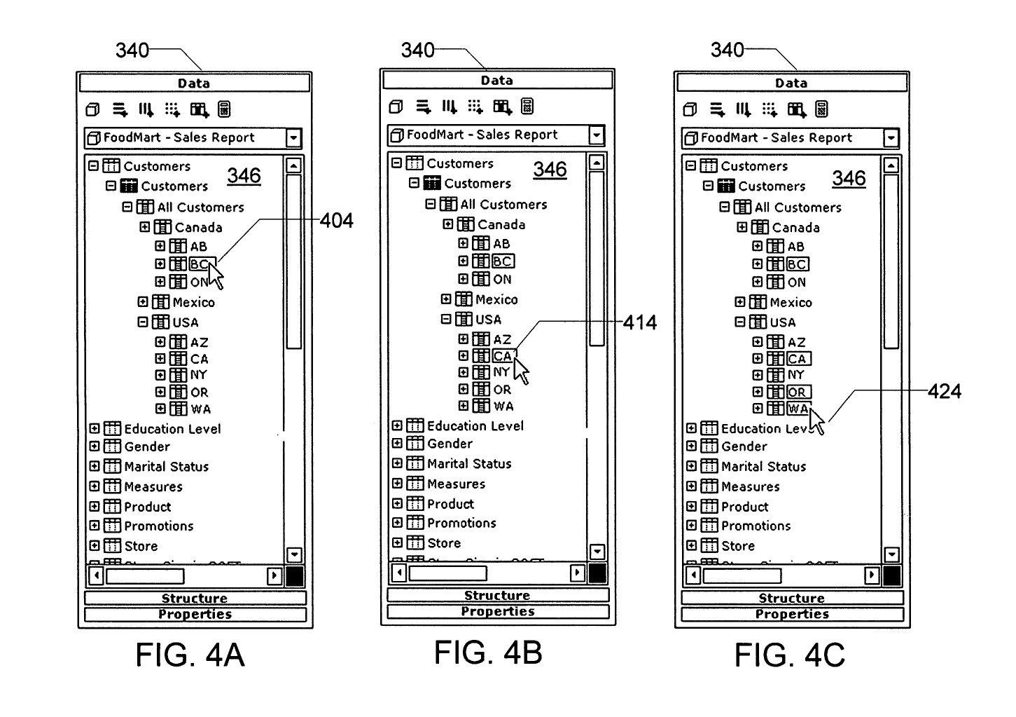

FIGS. 4A, 4B and 4C each illustrate a workflow for the GUI of FIG. 3 in accordance with an embodiment of the invention. In the displayed work flow a user selects items from different sub-trees using an alternative item selection method. Once the alternative selection method has been activated, that is, after processing operation 250 of FIG. 2, the user selects items corresponding to west coast states and provinces of the United States and Canada from the side pane 340 of FIG. 3.

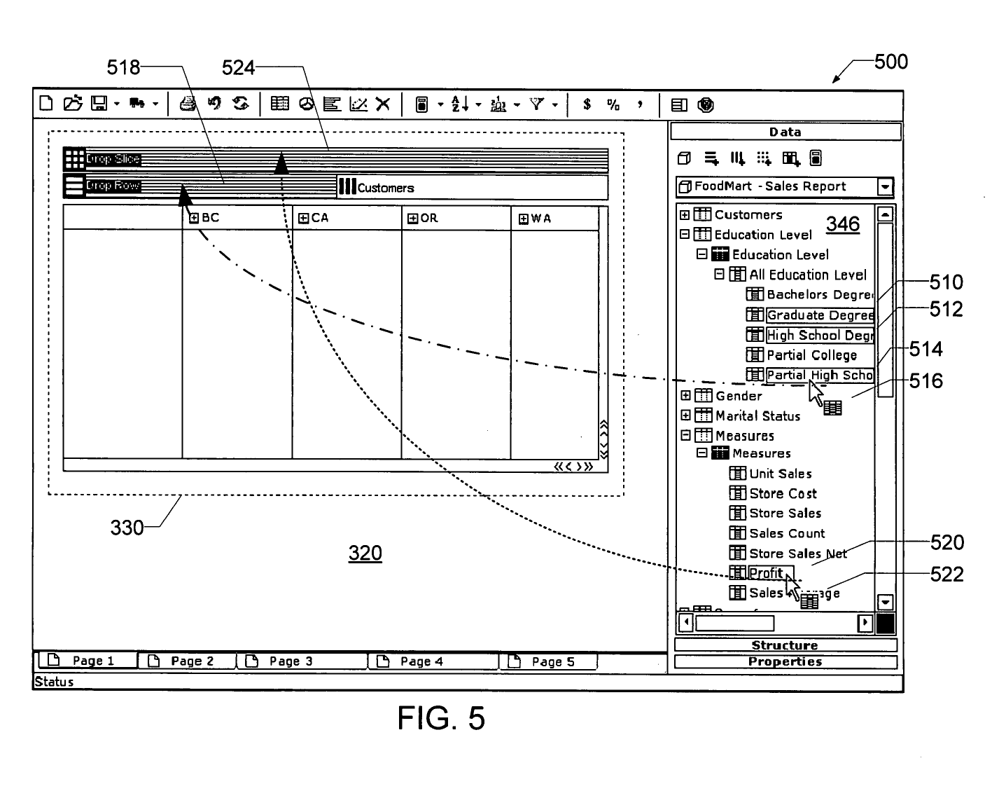

In FIG. 4A the user moves a cursor within the GUI to a side pane where alternative item selection is enabled. The user may then click on an item 404 toggling it to the selected state. In FIGS. 4A, 4B and 4C the selected state is denoted by an outline box, other highlighting techniques could also be used. One click, e.g., depression and release of a mouse button, toggles the state of the item which is clicked on. In FIG. 4B the user may then click on another item 414 toggling it to the selected state. In FIG. 4C the user may then click on yet another two items 424 toggling them to the selected state. The user can unselect an item by clicking on a previously selected item. Once one or more items are selected the user can perform a drag-and-drop operation. That is, the user can transfer one or more items from a source region to a target region. An example of source and target regions are different panes in FIG. 3. This activity, corresponding to processing operation 256 of FIG. 2, is shown in FIG. 5

In addition to the operations shown in FIGS. 4A, 4B and 4C, the user can perform additional manipulation activities with the source items, such as, be able to toggle the display mode between a tree and flat list, perform a search, select a range of items using pointer clicks and controlled clicks described above.

FIG. 5 illustrates a workflow for an embodiment of the invention. A source region, side pane 346, is displayed. Then a target region, layout pane 320 or cross-tab 330 within layout pane 320, is displayed within a portion of the GUI. After selecting multiple items from the source region a user half-clicks and drags one or more items from the source region to the target region. For example, items 510, 512, and 514 from the education level dimension are dragged from region 346 to a portion 518 of cross-tab 330. The portion of the cross-tab, or any other region that can accept a drag-and-drop from region 346, can highlight with a “mouse over” as shown. Another example of a drag-and-drop is that of item 520, via action 522, to another portion of the cross-tab, 524.

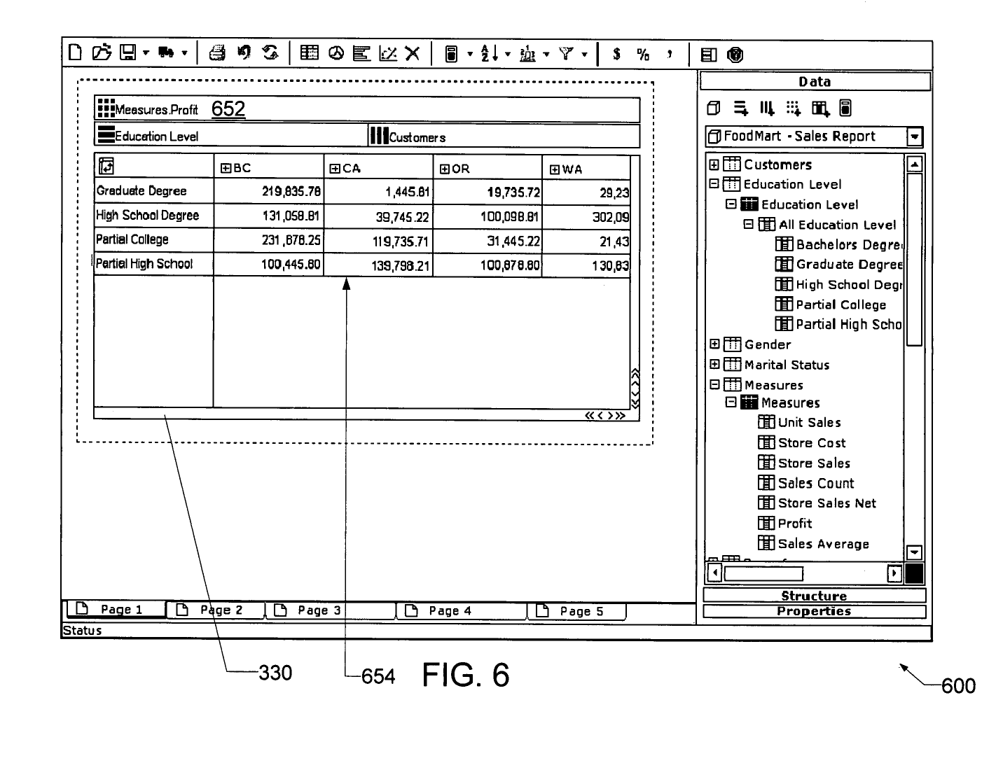

FIG. 6 illustrates the results of the workflow of FIGS. 4A, 4B, 4C, and 5 for the GUI of FIG. 3. In particular, FIG. 6 illustrates the result of a plurality of items that have been dragged from region 346 in the side pane and dropped in cross-tab 330 on the layout pane 320. The column values, row values, and slice values of the cross-tab are populated.

Data in layout pane 320 can be moved to another file such as a word processing document. The user selects items, such as text 652, arrays 654, or graphics from the layout pane 320 and performs a drag-and-drop to transfer the items to a second file. A portion of text can range from a single field to an entire document. One or more cells in an array can be transferred. The selection of two conjoined cells for a copy operation often results in the cells being pasted in the other file conjoined. A graphic, perhaps a chart derived from the data in cross-tab 330 could be drag-and-dropped into another file.

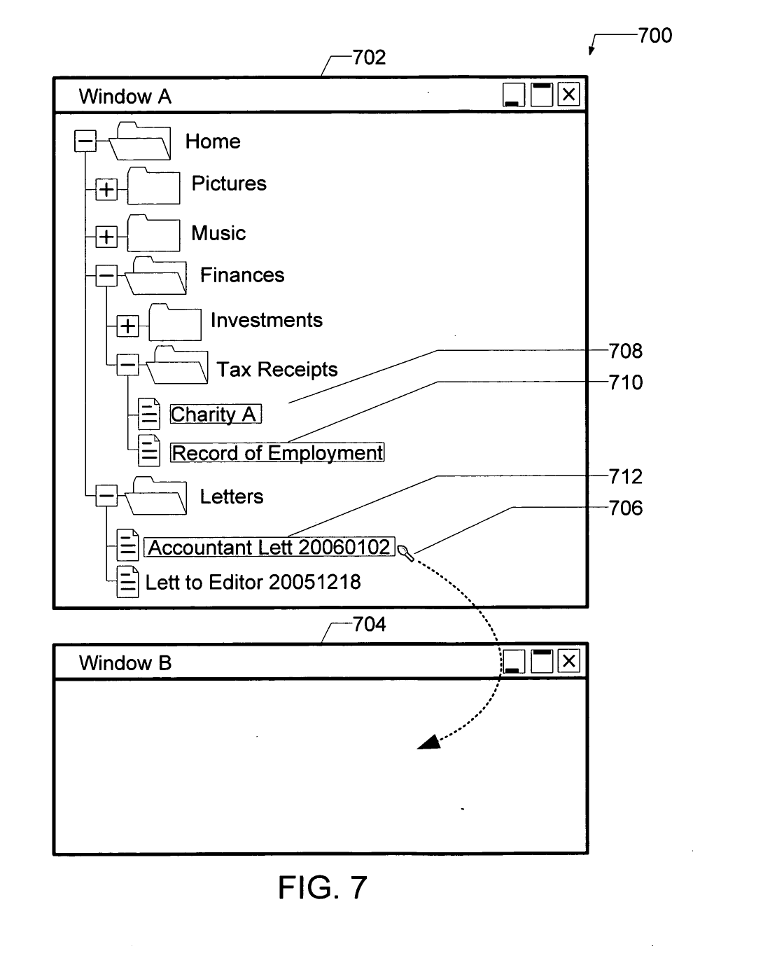

FIG. 7 illustrates a GUI and a workflow in accordance with an embodiment of the invention. FIG. 7 illustrates the interaction between two windows during a drag-and-drop operation. An output device of computer 100 displays two windows in a GUI: Window A 702 and Window B 704. In FIG. 7 there is a plurality of items in Window A 702 which the user wishes to move to Window B 704. The items in Window A 702 are arranged in a hierarchal manner displaying both directories and files. Other arrangements of items are possible. In an embodiment of the present invention, the activation of alternative item selection includes changing the cursor to a distinctive cursor such that the user is aware that alternative item selection is activated. An example of a distinctive cursor 706 is shown. A user selects items to move or copy from Window A 702 to Window B 704. The user clicks on a set of previous unselected items: 708, 710, and 712. Shown in FIG. 7 the user has selected three items from two different directories. The user then performs a drag-and-drop operation by depressing a mouse button while over a previously selected item and without releasing the button drags the selected items to Window B 704.

In an embodiment of the present invention, a drag-and-drop operation can occur without a separate mouse click. A selection can be made as a result of depressing a mouse button, just before the user starts dragging. For example, the user can select and drag an item in a single gesture; the user does not have to click the item first, release the mouse button, and then press again to begin dragging the item. This can be applied to one item or a selection of items. In FIG. 7 the single gesture drag-and-drop begins by cursor 706 selecting items 708, 710, and 712 without releasing the mouse button. The user then begins a drag operation.

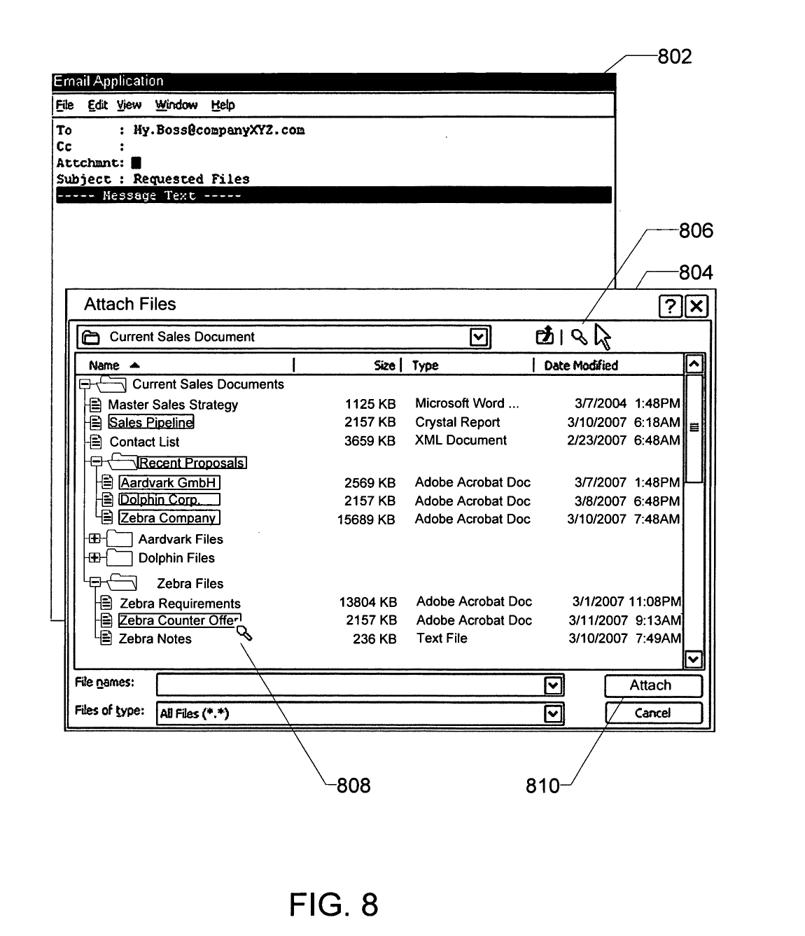

FIG. 8 illustrates a GUI and a workflow in accordance with an embodiment of the invention. FIG. 8 illustrates a workflow of a user selecting one or more items from within a program's window. An output device of computer 100 displays a window 802 in a GUI with a program running in it. For example an email program as shown in FIG. 8. A user selects one or more items in a browser window 804, which is a file selection program for attaching files to an email. A user can employ alternative item selection to select files to attach to the email. The user can optionally switch between alternative item selection and normal multiple file selection. A tool bar 806 can be provided for this. The user selects items in accordance with an embodiment of the present invention 808. Once the user has selected the files he or she desires, the user can attach them to the email program via the attach button 810.

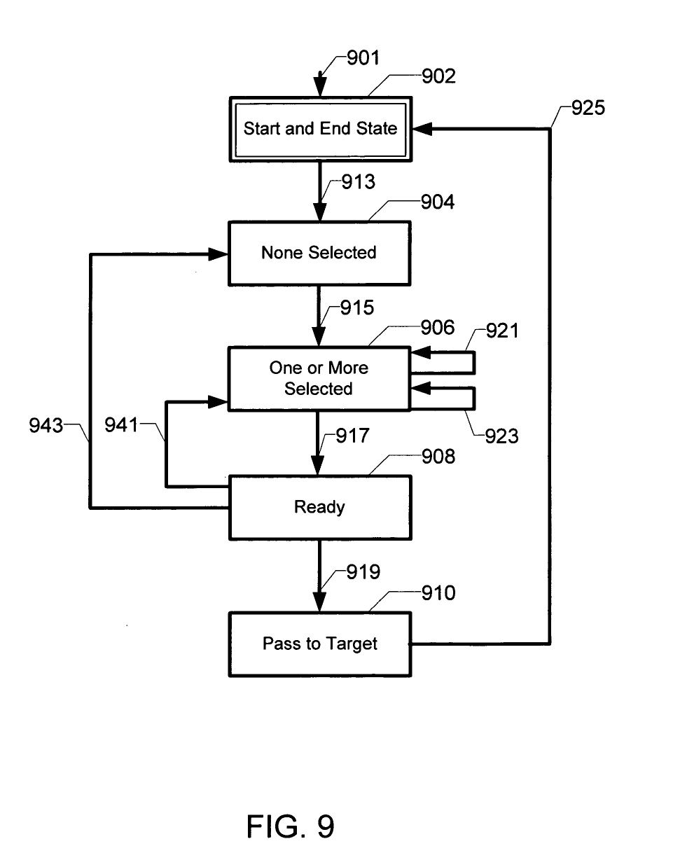

FIG. 9 illustrates a state diagram 900 associated with an embodiment of the invention. State diagram 900 graphically represents the state of computer 100 and how it changes state based on inputs. FIG. 9 could be equally well represented as a state transition table. The state diagram 900 is a directed graph where each edge is a transition between two states. The edges correspond to inputs by a user. The states are states of the computer 100, or in a multi-threaded computer the state of computer 100 as it executes instructions in GUI module 114 and alternative selection method module 116.

Included in state diagram 900 is a Start and End state 902. Absent user input, the computer remains in the Start and End State 902. A None Selected state 904 is entered by transition 913 when a user activates the alternative item selection method. By clicking on an item, the One or More Selected state 906 is arrived at via transition 915.

The One or Mores Selected state 906 of state diagram 900 has two loops. Loops are edges that begin and end at the same state. Loop 921 is a transition in which the user clicks on another item in the same sub-region as the item clicked in transition 915. With this click one or more items remain selected so the computer 100 remains in state 906. Loop 923 is where a user clicks on another item that is not in the same sub-region as the selected items. The items previously selected are discarded in favor of the newly selected item. With this click one item remains selected so the computer 100 remains in state 906. Examples of selecting an item that is in a different sub-region include selecting a file on a different physical drive than previously selected files, or in an OLAP tool clicking on a new dimension of a hypercube.

Transition 917 takes computer 100 to the Ready state 908. The Ready state 908 is an optional state, embodiments of the present invention can function without it by having transition 917 lead to state 910. Transition 917 is where a user half-clicks on a previously selected item leading to the Ready state 908. The user can unclick the previously selected item by releasing the half click for a full mouse click. Thus via transitions 941 or 943 the state reverts to states 906 or 904 respectively. Or, the user can drag-and-drop the selected item into another location within the graphical user interface, depositing the selected items there. This is transition 925.

From states 904, 906, 908, and 910 the state of computer 100 can be returned to the Start and End state 902. The transitions for this can be effected by a cancel input from the user. The inverse operation to the operation that caused transition 913 could be a cancel input. Alternatively, the cancel input could be a keyboard type, e.g., “ESCAPE”. When the transition 913 is caused by the computer 100 detecting a change of focus of the user within the graphical user interface to a location with a window where alternative item selection is enabled, a cancel input can detect the reverse change of focus.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A method of selecting multiple items in an application running within a window of a graphical user interface on a computer, comprising:
activating an alternative selection mode within the graphical user interface; and
selecting previously unselected items to create a plurality of selected items, wherein each item in the plurality of selected items is selected with a single input action.

2. The method of claim 1 further comprising deselecting a previously selected item with a single input action.

3. The method of claim 1 wherein the alternative selection mode is a default mode.

4. The method of claim 1 wherein the alternative selection mode is activated by a change in focus.

5. The method of claim 1 wherein the alternative selection mode is activated by a user-driven event.

6. The method of claim 5 wherein the input action is one of: a mouse click or a keyboard stroke.

7. The method of claim 1 further comprising performing a drag-and-drop operation with the plurality of selected items.

8. The method of claim 7 wherein the drag-and-drop operation includes a half-click on an item and a drag motion.

9. The method of claim 1 further comprising generating a digital signal embodied in a carrier wave that includes the plurality of selected items.

10. A computer readable medium, comprising executable instructions to:
identify an alternative selection mode within a graphical user interface; and
link, during the alternative selection mode, a set of selected items, wherein each item in the set of selected items is individually selected with a single input action.

11. The computer readable medium of claim 10 further comprising executable instructions to deselect, in response to a single input action, an item within the set of selected items.

12. The computer readable medium of claim 10 wherein the alternative selection mode is a default mode.

13. The computer readable medium of claim 10 wherein the alternative selection mode is activated by a change in focus.

14. The computer readable medium of claim 10 wherein the alternative selection mode is activated by a user-driven event.

15. The computer readable medium of claim 10 wherein the input action is one of: a mouse click or a keyboard stroke.

16. The computer readable medium of claim 10 further comprising executable instructions to facilitate a drag-and-drop operation with the set of selected items.

17. The computer readable medium of claim 16 wherein the executable instructions to facilitate are responsive to a half-click on an item and a drag motion.
